(19) United States
(12) Patent Application Publication
(10) Pub. No.: US 2006/0223360 A1
(43) Pub. Date: Oct. 5, 2006

(54) Electric equipment module structure

(75) Inventors: Shingo Chiba, Shizuoka (JP); Haruyuki Matsushita, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAZAKI CORPORATION, Tokyo (JP)

(21) Appl. No.: 10/564,087

(22) PCT Filed: Jul. 14, 2004
(86) PCT No.: PCT/JP04/10370

§ 371 Date: Jan. 11, 2006

(30) Foreign Application Priority Data
Jul. 17, 2003 (JP) 2003-198220

(51) Int. Cl. H01R 4/24

(52) U.S. Cl. 439/404

(57) ABSTRACT

A case 1 comprises a base 2 and a cover 3, a terminal is disposed in the case, an electric wire 8 connected to the terminal is arranged in the base, a cutout portion 12 to bend and guide out the electric wire is penetrated and formed in the base 2, and an electric equipment module structure in which the outside opening of the cutout portion is closed by the cover is adopted. A projection 13 pressing the electric wire 8 in the cutout portion 12 is formed in the cover 3, and the electric wire is bent along with the projection 13. The base 2 and cover 3 have a connection portion 14 at the end, and have a connected portion 15 at the other end, respectively, and a plurality of cases 1 can be connected mutually. The connection portion 14 biases the base 2 and cover 3 in the closing direction.

### TECHNICAL FIELD OF THE INVENTION

This invention relates to the electric equipment module structure which provides a strain-relief function to electric wire for supplying electric power, such as to illuminant, and raises the usability of lamp module etc. capable of a plurality of connections.

### BACKGROUND ART

Various forms of lamp module have been conventionally proposed as for internal lighting in the ceiling of vehicles etc. Connector module attached in the trim of a ceiling etc. for connecting the circuit of the ceiling side is also proposed.

FIG. 9 shows a sun visor connector 51 as an example previously proposed by this applicant, provided with a case comprising a base 52 and cover 53 made of a synthetic resin, a pressure contact terminal 54 arranged at the base 52. An electric wire 55 is wired in bent to the U-shape above and below of the base 52 and the cover 53. The sun visor connector 51 is fixed to the trim of the ceiling, the connector of the sun visor being fitted inside of the recess 56 of the base 52, and connected to the tab terminal (not shown) following the pressure contact terminal 54.

The electric wire 55 is depressed and bent 90° at a corner 57 inside the cover 53, being further bent to an opposite direction along with a flange portion 58 outside the cover 53, so as to be bent in a generally crank shape, resulting in strain-relief function, i.e., avoiding unreasonable load to the pressure contact part (the connection portion of the electric wire 55 to the pressure contact terminal 54) to hold a tensile force to the electric wire 55. This strain-relief structure is also applied to lamp module (not shown).

However, the above-mentioned conventional connector module bends the electric wire 55 to a generally crank-shape for strain-relief and causes problems of the increase of the height of the case and the scale of the structure. The same situation also occurs also to lamp module.

Moreover, in the above-mentioned lamp module, when the illumination intensity is not enough with a single lamp or a plurality of lamps are arranged by the same pitch, it is difficult to arrange a plurality of lamps in the same direction due to the repulsive force for the bent of the electric wire 55, and causes an allophone and wear by the vibration under vehicles run due to the chattering of the base 52 and cover 53. The same situation occurs in arranging a plurality of connector modules in series.

The objective of the present invention is to solve the problems and aims to provide an electric equipment module structure, in generally, with increased usability (usability), capable of downsizing the whole electric equipment module, such as connector module or lamp module, by a strain-relief structure saving space, arranging simply and assuredly the connector module in series, using a plurality of lamps according with the specification of illumination of the lamp module at the same time, and preventing the chatter thereof.

### DISCLOSURE OF THE INVENTION

In order to achieve the above object, the electric equipment module structure according to claim 1 of the present invention is characterized in that an electric equipment module structure comprises a case having a base and a cover, the case is provided with a terminal, an electric wire connecting with the terminal is arranged in the base, a cutout portion for bending and guiding the electric wire is provided through the base, and the outside opening of the cutout portion is closed by the cover.

Thereby, the electric wire is bent along the upper end of the cutout portion and inserted through inside the cutout portion downwardly, again is bent for reverse at the position passed through, is bent in the shape of a crank as a whole, and the strain-relief action, i.e. the resistance to the tensile force of the electric wire is achieved and reduces the stress to the electric wire connection portion. The outside opening of the cutout portion is closed by the cover and the upper and lower opening (perpendicular) serves as the electric wire insertion hole. Since the electric wire passes through the electric wire insertion hole from top to bottom, the perpendicular length of the electric wire bent is secured and the strain-relief is ensured. Moreover, the case is made in thin shape, the electric equipment module structure is miniaturized.

The electric equipment module structure according to claim 2 is characterized in that the projection for pressing the electric wire is disposed in the cover at the cutout portion in the electric equipment module structure described in claim 1.

Thereby, the projection of the cover closes the outside opening of the cutout portion with the cover, and secures the above-mentioned electric wire insertion hole still longer. The electric wire is bent outward along with the projection, and is pressed by the projection downwardly (in the direction of the diameter of the electric wire). Thereby, the increase of a drag for the tension of the electric wire and a strain-relief action are promoted. The projection of the cover is engaged with the cutout portion of the base and acts also as a positioning portion and a position-gap prevention portion to the base.

The electric equipment module according to claim 3 is characterized in that the case comprises the base and the cover, the case is provided with the terminal, the electric wire connecting the terminal is arranged in the base, the base and the cover have a connection portion at one end and a connected portion at another end, respectively and a plurality of cases are possible to connect mutually.

Thereby, the connection portion of the case of one electric equipment module engages with the connected portion of the case of the another electric equipment module, and both electric equipment modules are connected. Both electric equipment modules are preferably connected without clearance from a viewpoint of saving space. Thereby, for example, the illumination of the lamp module rises and two illuminants are arranged at a fixed interval. The partner connector fitting portion of the connector module of the same form is arranged at a fixed interval. The number of the electric equipment modules to connect is not only two but three or more than that.

The lamp module structure according to claim 4 is characterized in that the connection portion biases the base and the cover in the closing direction in the electric equipment module structure described in claim 3.

The base at each connection portion is pressed to the cover and the cover is pressed to the base by this constitution. Thereby, the clearance between the base and cover is eliminated and the chattering between the base and cover during the vehicle run (locking chattering) is prevented.

The lamp module structure according to claim 5 is characterized in that the electric equipment module structure described in claim 1 or 2 is provided with the constitution of the electric equipment module structure described in claim 3 or 4.

The above-mentioned constitution shows the action and effect of having united claim 1 or 2 and claim 3 or 4.

The electric equipment module structure according to claim 6 is characterized in that the illuminant is disposed in the case, and the terminal is electrically guided to the illuminant in the electric equipment module structure described in any one of claims 1 to 5.

The above-mentioned constitution demonstrates an action and an effect same as the lamp module to the electric equipment module described in claim 5. For example, in claim 3, the connection portion of the case of one lamp module engages with the connected portion of the case of another lamp module, and both lamp modules are connected. Both lamp modules are preferably connected without clearance from the viewpoint of saving space. Thereby, the illumination rises and two illuminants are arranged at a fixed interval.

### BRIEF DESCRIPTION OF THE DRAWINGS

FIG. 1 is a perspective view showing one embodiment of the lamp module structure as one embodiment of the electric equipment module structure according to the present invention.

FIG. 2 is a perspective view showing the structure of the base side of a lamp module.

FIG. 3 is a perspective view showing the state where the electric wire is connected to the base side.

FIG. 4 is a perspective view showing the cover side structure of the lamp module.

FIG. 5 is a perspective view showing the main part of the cover comprising a base and a cover.

FIG. 6 is a perspective view showing one embodiment of the connection structure of the lamp module.

FIG. 7 is a longitudinal sectional view showing the connection structure of the lamp module.

FIG. 8 is a perspective view showing the connection of the base side and the structure of the electric wire connection.

FIG. 9 is a longitudinal sectional view showing a connector module having a conventional strain-relief structure as an example.

### PREFERRED EMBODIMENT OF THE INVENTION

The embodiments of the present invention are described with reference to the attached drawings.

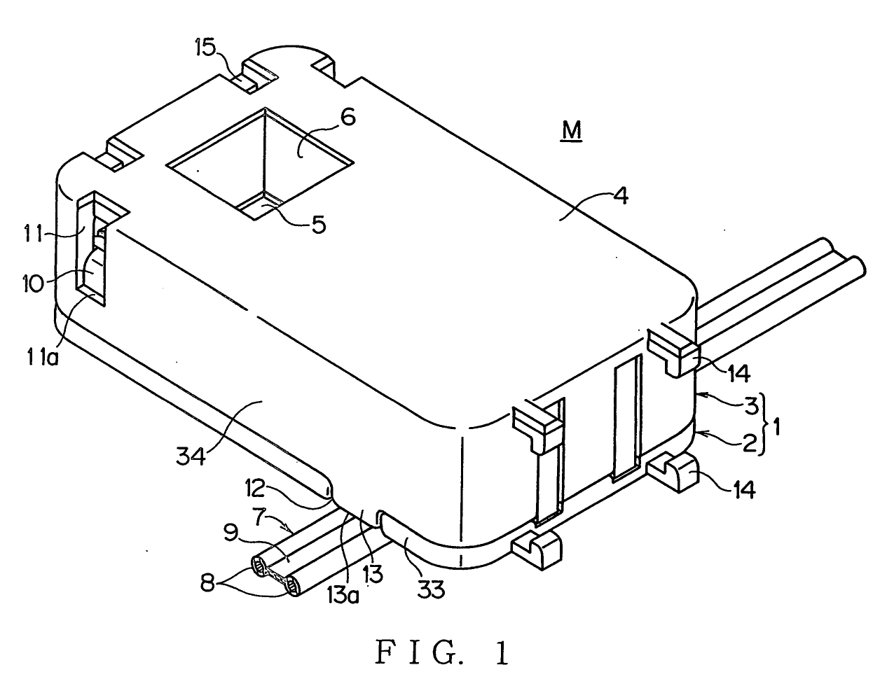

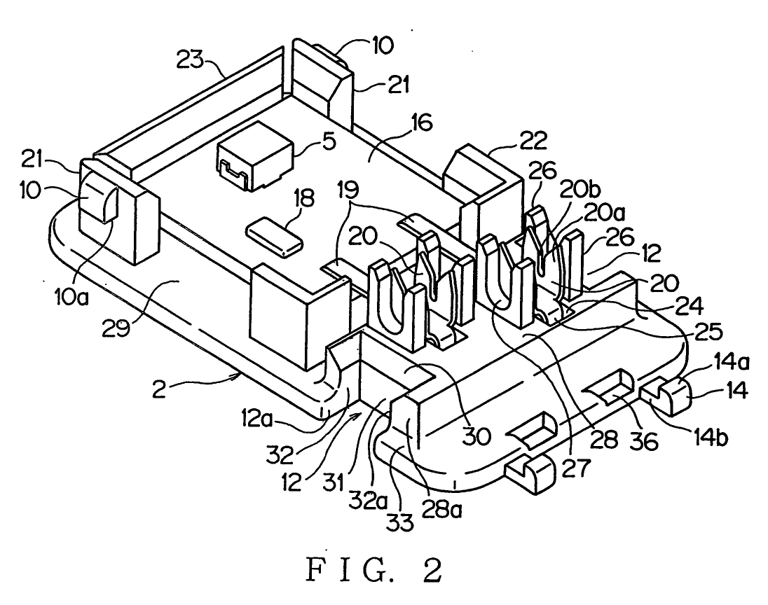

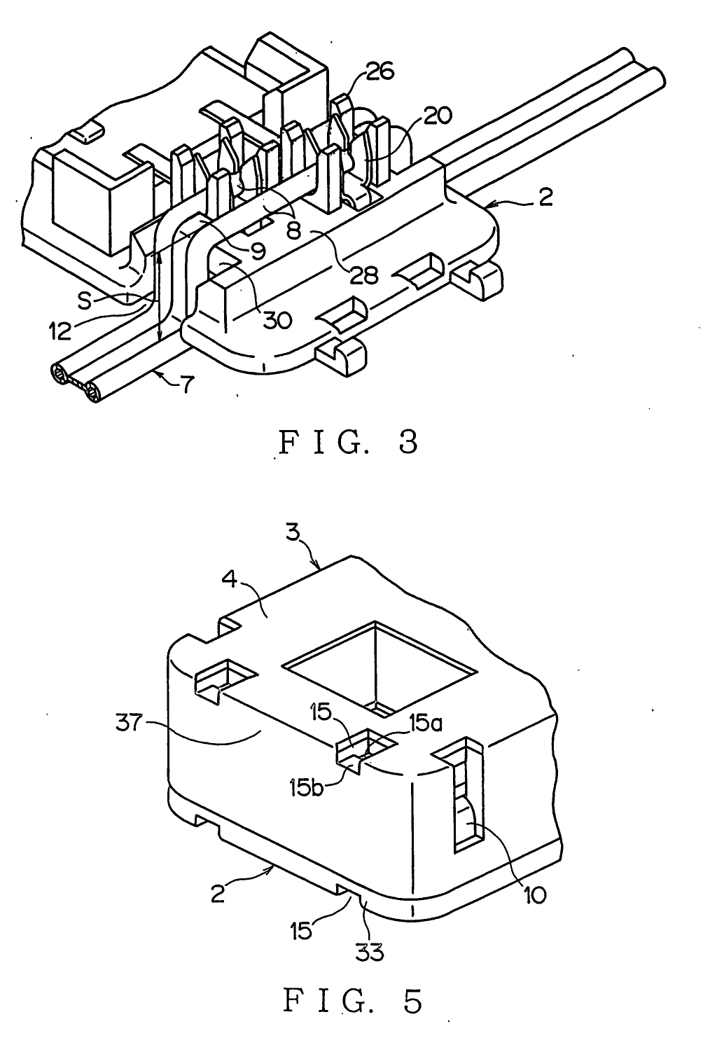

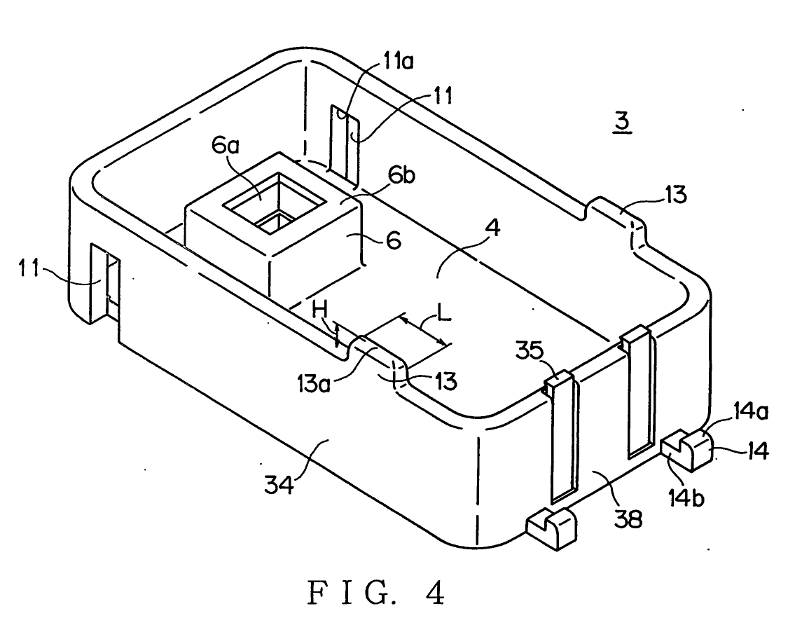

FIGS. 1 to 5 show an embodiment of a lamp module structure as one of the embodiments of an electric equipment module according to the present invention. FIG. 1 shows the overall view of a case (lamp module), FIG. 2 a base side structure, FIG. 3 an electric wire pressed to the base side, FIG. 4 the structure of a cover, and FIG. 5 the structure of one end side of the case, respectively.

As shown in FIG. 1, the case 1 made of synthetic (insulation) resin which comprises of the base 2 and the cover 3 is formed in a thin shape of a generally rectangular parallelepiped. A tapered window 6 following a light emitting face of an LED 5 of illuminant (Light Emitting Diode as illuminant) is formed in a top wall 4 of the cover 3, a flat cable 7 is wired in a crossing direction in the case 1 at the opposite end side of the window 6.

The base 2 and the cover 3 are mutually locked with locking means 10 and 11 to mention later. The flat cable 7 comprises two insulated covering electric wires 8, + side and − side, interconnected by a thin connection belt 9. The flat cable 7 is guided out from a cutout portion 12 of the base 2 by lower part and is extended horizontally, and the strain-relief is made by pressing a projection 13 of the cover 3 in the cutout portion 12. Connection means 14 and 15 are formed in the both ends of the narrower side of the case 1, and two lamp modules M can be mutually connected with the connection means 14 and 15.

As shown in FIG. 2, a circuit board 16 is arranged on the base 2 of the case 1, a tipped type LED 5 or a resistor 18 is surface-mounted on the circuit board 16, two bus bars, + pole and − pole, 19 are projected from the circuit board 16, and a pressure contact terminal (terminal) 20 is formed with each bus bar 19 in uprising. The bus bar 19, resistor 18, and LED 5 are connected in a circuit such as other bus bars, copper foil, and print circuit (not shown). Resistor 18 is for reducing the voltage from the flat cable 7 (FIG. 1), and supplying to LED 5.

The circuit board 16 is laid on the level rib on the base 2 (not shown), and the crossroads or four quarters is surrounded by walls 21-23 for positioning. The right and left side wall 21 is provided with the locking projection 10 as projecting means for the cover 2 (FIG. 1). The bus bar 19 is locked by a recess 24 of the base 2 in the claw 25, one bus bar 19 is short and another bus bar 19 is projected lengthwise, and the pressure contact terminal 20 of each bus bar 19 is arranged back and forth in the lengthwise direction of electric wire in the pitch corresponding to two parallel electric wires 8 of the flat cable 7 (FIG. 1). The pressure contact terminal 20 of each pole is arranged oppositely in pair, and each pressure contact terminal 20 is supported by a guide rib 26 projected from the base 2 at the outer surface side and is prevented from falling down.

The pressure contact terminal 20 has piece of pressure contact 20a of one pair of right and left, and a slot 20b for electric wire cutting between them. The guide rib 26 is formed one pair of right and left corresponding to the form of the pressure contact terminal 20, and has an electric wire insertion portion 27 in the center. A base portion 28 arranging the pressure contact terminal 20 is formed in thick in the shape of a plinth rather than the base portion 29 arranging the circuit board 16.

The both ends for guiding the electric wire of the plinth 28 are cut into the whole base 2 in the shape of a rectangle slot, and the above-mentioned cutout portion 12 is constituted. The cutout portion 12 has a curved or slanted bent guide side 30 for the electric wire in an upper end side, having a perpendicular surface of a wall 31 following the guide side 30, and the perpendicular surface of the wall 31 is mostly perpendicular to the undersurface (back) of the base 2. The both sides of the cutout portion 12 are surrounded in a wall 32 deeper than the outer diameter of the electric wire 8 (FIG. 1), and can receive each electric wire 8 in the cutout portion 12. Outside an opening 32a is located in the front end of the wall 32 of both sides.

A level base 29 of the base 2 extends from the plinth 28 below as a flange, and the side wall 34 of the cover 3 (FIG. 1) is capable of abutting over to the flange 33. The outside opening 32a is closed (covered) by the side wall 34. The cutout portion 12 is also cutout the flange 33.

As shown in FIG. 3, the connection belt 9 of the flat cable 7 is cutout in the middle of the lengthwise direction and is divided into two electric wires 8. Each electric wire 8 advances into the guide rib 26 from the upper part on the level plinth 28 and is pressed into the pressure contact terminal 20. The electric wire is smoothly bent downward (perpendicular) along the bending guide side 30 of the upper end of the cutout portion 12, is passed downward the cutout portion 12, and is guided to an electric supply or load side, being bent horizontally in the bottom of the cutout portion 12. The electric wire 8 passed the cutout portion 12 is projected below the undersurface (back) of the base 2 and is bent in the direction of 90° at the position.

The projection 13 for pressing the electric wire of the cover 3 as shown in FIG. 1 engages with the cutout portion 12 (the portion of numeral 12a of FIG. 2) of the flange 33 of the base 2 and pushes the electric wire down side to the flange 33 (the base plate 29) by covering the cutout portion 12. The electric wire 8 is bent downward at the upper end side of the cutout portion 12 by covering the cover 3. Furthermore, the electric wire 8 is horizontally bent along with the tip (lower end) 13a of the cutout portion 13 of the cover 3, and is formed as FIG. 1 by the worker. A side wall 34 of the cover 3 is positioned in the outside of the cutout portion 12, the front side of the cutout portion 12 is covered by the side wall 34 (state of FIG. 1), and electric wire insertion holes of the shape of a perpendicular rectangle with the opening of the upper part and the lower part is constituted (state of the cutout portion 12 being covered by the cover 3 of FIG. 3).

As shown in FIG. 4, the projection 13 for pressing electric wire of the cover 3 is arranged by a pair in symmetry fore and rear of the base 2 (FIG. 2) corresponding to a pair of the cutout portion 12 at the tip of the both side wall 34 of the long side. The projection 13 has a curved or slanted tip face 13a, and the electric wire 8 (FIG. 3) is smoothly bent along with the face 13a. The width L of the projection 13 is smaller than the width of the cutout portion 12 a little, and the projection length H of the projection 13 is equal to the board thickness of the base plate 29 of the base 2 (FIG. 2). The projection 13 is resin-molded in the side wall 34.

The cover 3 is formed in the rectangular shape by a level top wall (upper wall) 4 and a perpendicular peripheral wall (substituted by numeral 34) intersecting perpendicularly with the top wall 4, continuing circumferentially, and the above-mentioned window 6 of rectangle frame is formed together in the inside of the top wall 4. LED 5 on the base 2 of FIG. 2 moves in and engages with at a space 6a inside the window, a tip (lower end) 6b of the window (frame) 6 presses down the circuit board 16 on the base 2 of FIG. 2, and makes it stabilize to remove chattering.

An engaging bore(engaging means) 11 to the locking projection 10 (FIG. 2) of the base 2 is formed in the wall 34 of the both sides of the cover 3. The inside of the circumferential wall 34 of the cover 3 is smoothly guided along the wall 21-23 (FIG. 2) for positioning of the base 2 and the edge 28a of the plinth 28. The locking projection 10 (FIG. 2) bows down outward the side wall 34 of the cover 3 near the engaging bore 11 or the wall 21 having the locking projection 10 bows down inward, the locking projection 10 enters and engages into the engaging bore and the level locking face 10a (FIG. 2) of the locking projection 10 abuts to the lower end face 11a (FIG. 4) of the engaging bore 11. The wall 21 covers the engaging bore 11 from inside.

The window frame 6 (FIG. 4) presses down the circuit board 16 (FIG. 2) at the same time, and the projection 13 for pressing down the electric wire within the cutout portion 12 presses down the electric wire 8 downward, as shown in FIG. 1, so as to exercise strain-relief. A positioning projection 35 (FIG. 4) of the cover end by the opposite side of the engaging bore 11 engages with the recess 36 (FIG. 2) of the front end of the base 2. The positioning projection 35 is also capable of the locking projection.

The electric wire 8 penetrates and projects lower the cutout portion 12 by the projection 13 for pressing down the electric wire and the perpendicular distance S of the electric wire 8 can be set up long, thereby sufficient strain-relief function can be demonstrated even when the case 1 (lamp module M) is set as thin type.

As shown in FIG. 1, a flexible connection piece 14 (connection portion) is provided saliently each pair of upper and lower on the level at the end side of opposite (back end) in the window 6 of the case 1. The upper connection piece 14 is arranged at the upper end side of a back wall 38 which is a part of the circumferential wall of the cover 3 of FIG. 4, has downward projection (nail) 14a, and the lower connection piece 14 is arranged at the end by the short side of the circuit board 29 of the base 2 of FIG. 2, and it has upward projection (claw) 14a. Each connection piece 14 comprises a level flexible support 14b and a projection 14a provided saliently inside the support 14b.

As shown in FIGS. 1 and 5, a recess (connected part) 15, i.e., the receptacle part for engaging each connection peace 14 is provided at the end by the short side of the case 3 by the opposite side (front end) of the connection piece 14. Each recess 15 is formed in step with a shallow groove 15b for the support 14b of each connection piece 14 and a deep hole 15a or groove for the projection (claw) 15a. The recess 15 in the cover 3 is formed at the intersection of the top wall 4 and the front wall 37 as the part of the circumferential wall, and the recess 15 in the base 2 is formed in the flange 33.

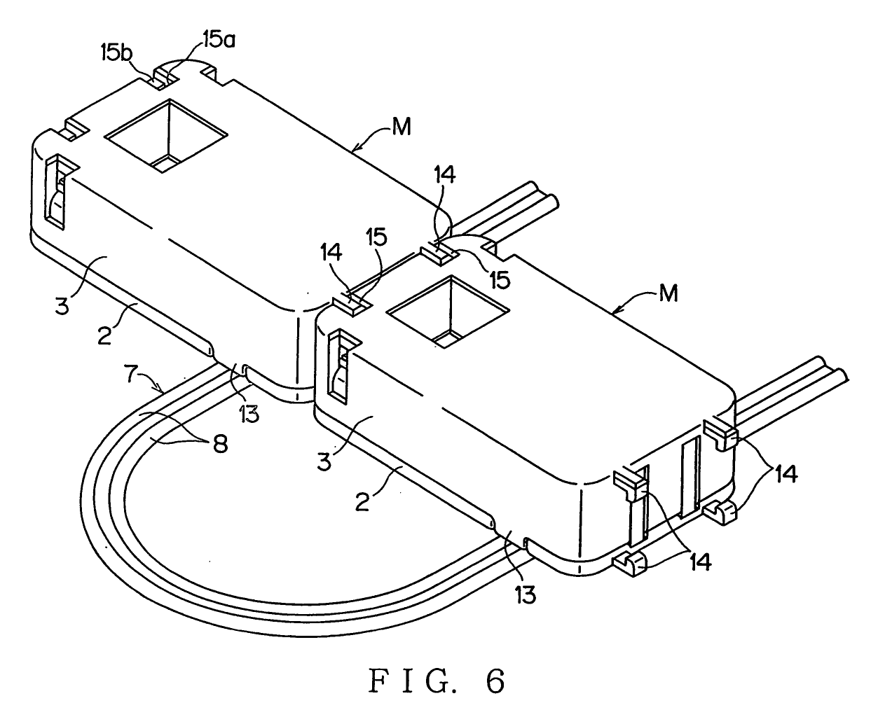

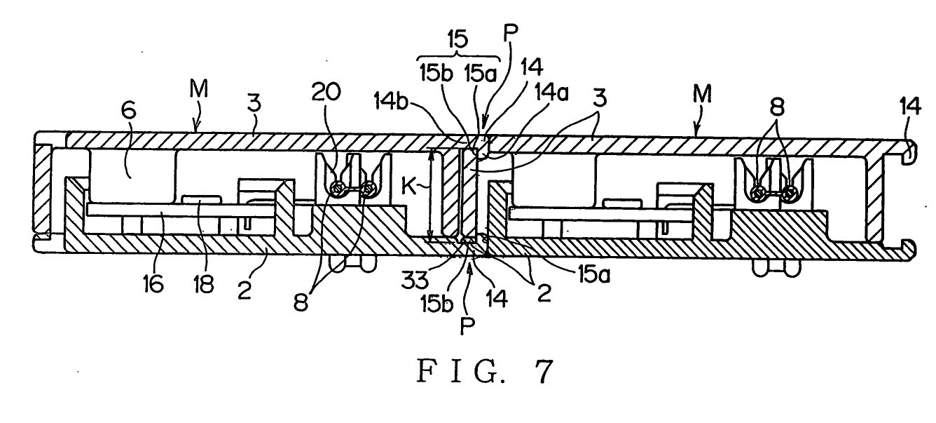

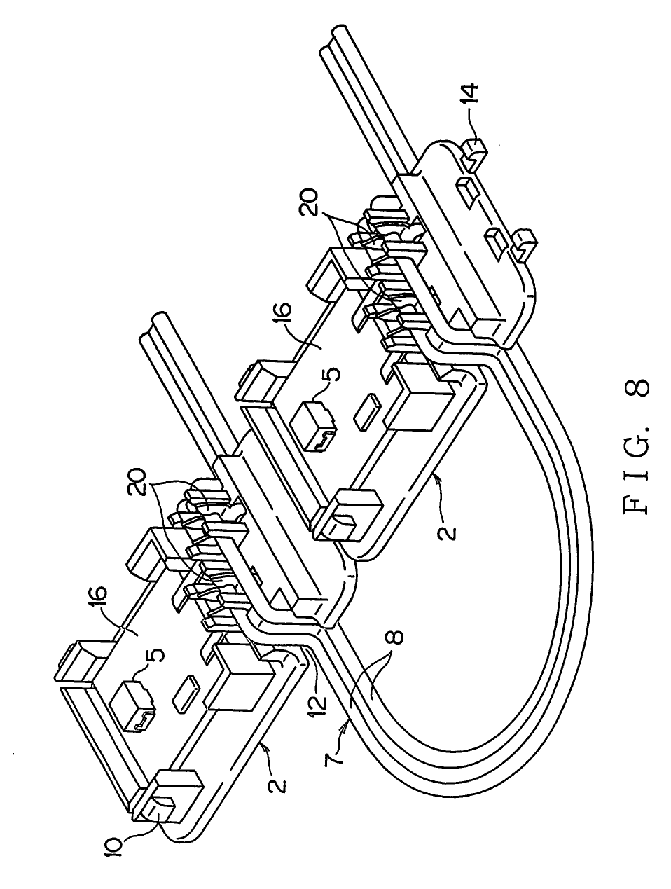

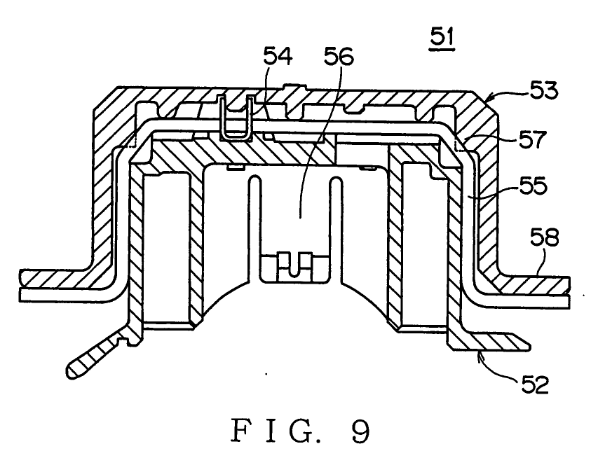

FIGS. 6 to 8 show the connection structure of the above-mentioned lamp module as one embodiment of the connection structure of an electric equipment module. FIG. 6 shows one embodiment of a connection state, FIG. 7 a longitudinal section, and FIG. 8 an example of electric wire arrangement, respectively.

When lamp illumination is required to increase or illuminant 5 is arranged in parallel in a plurality of same pitches, a plurality of lamp modules (the number of requests) is capable of connecting fore and rear.

Suppose, for example, the near side lamp module M to be the extension side. Connection of both the lamp module M is performed by making each connection piece 14 of one lamp module M engaging to the recess 15 of the lamp module M of another side. The connection is carried out by moving (approaching) mutually both the lamp module M in the case lengthwise direction, i.e., the projection direction of the connection piece 14. The connection piece 14 runs aground to the shallow groove 15b first and bends outward, the projection 14a of the connection piece 14 engages to the deep hole 15b or groove, and restores inward resulting to the smooth connection.

As shown in FIG. 7, the upper and lower connection piece 14 reverts elastically at the time of connection, nipping the base 2 and cover 3 of the other lamp module M in a closing direction, a clearance between the base 2 and the cover 3, i.e., chattering is eliminated, and allophone, wear, etc. by vibration of the vehicles run etc. are prevented certainly.

Preferably, in order to attain the above action, the interval K of the support 14b of the upper and lower connection piece 14 is set as the size equal to or not more than the interval of the recess 15 of the upper and lower sides of the case 1. The upper connection piece 14 abuts a shallow groove 15b of the upper end side of the cover 3, the lower connection piece 14 abuts a shallow groove 15b of the flange 33 of the base 2; and the cover 3 and the base 2 are pressed down to the connection direction such as the arrow P, i.e., in opposition to the cover opening.

As shown in FIG. 6, one lamp module M and another lamp module M are preferably connected in the state as the flat cable 7 being turned up in the shape of U character. Since each lamp module M is connected without a clearance, the amounting space can be saved. This is realized by turning up the electric wire 8 in the shape of U character.

For example as shown in FIG. 8, after each electric wire 8 is pressed down to the base 2 side of one lamp module M, the base 2 of another lamp module M is arranged in parallel and in opposite direction to the another, the electric wire 8 is pressed down to the base 2 side, each cover 3 (FIG. 6) is then covered, and the another lamp module M is connected by reversing as shown in FIG. 8.

The electric wire 8 is pressed with a U-turn in the state both lamp module M being turned in the same direction, the cover 3 is covered, and both lamp module M is joined. Each electric wire 8 is pressed in the state of both base being joined as shown in FIG. 8, and connected while covering both covers 3 etc. The method of press and connectio can be set suitably.

Both the lamp module M, in any case, are connected with one flat cable 7 in series. The flat cable 7 is bent in the shape of a crank penetrating the cutout portion 12 of each base 2 up and down, and pressed by the projection 13 of the cover 3 so as to achieve the strain-relief.

In addition, it is also possible to replace the pressure contact terminal 20 connecting the electric wire 8 in the above-mentioned embodiment, with connection means, such as a crimp type terminal (not shown), welding etc. Moreover, the light emitting face of LED 5 is not only facing up but also located in the window etc. of the side wall 34 of the cover. Moreover, LED 5 is not limited to a tipped type but also possible for a bulb type, and it is possible to replace the LED 5 with a regular bulb although miniaturization is difficult. Moreover, the electric wire 8 is not restricted to a flat cable, but also possible for use independent two main lines, a twist line, etc.

Moreover, it is also possible to replace the strain-relief structure of the above-mentioned electric wire with a lamp module, and to apply to a connector module (not shown) In this case, the pressure contact terminal 20 of FIG. 2 follows to a tab terminal (not shown), for example, through the bus bar or directly, and the tub terminal or the shave, i.e. connecting terminal following the tub terminal is positioned in the connector fitting portion (not shown) disposed in the base 2. Neither the circuit board 16 nor the illuminant 5 is used.

Moreover, the connection structure of the above-mentioned electric equipment module can be applied to a connector module (not shown) instead of the lamp module. In this case, the fitting portion for partner connector disposed in the base 2 of FIG. 6 positions in parallel with a same pitch.

### EXPLANATION OF INDUSTRIAL APPLICABILITY OF INVENTION

According to the invention described in claim 1, the perpendicular length of the electric wire bend portion is secured at the cutout portion of the case, and the strain-relief is surely made, so as to achieve thinner. Then, the electric equipment module can be attached to narrow attachment portions, such as vehicles, easily and certainly with a saved space.

According to the invention described in claim 2, since the projection of the cover secures the perpendicular length of the electric wire bend part still longer, the strain-relief function of the electric wire and the miniaturization of the module structure are promoted. Moreover, the projection of the cover presses the electric wire in the direction of a path, the strain-relief action of the electric wire is promoted, and the reliability of the electric wire connection part increases. Thereby, the usability of the electric equipment module improves further.

According to the invention described in claim 3, the connection of a plurality of electric equipment modules, for example, accommodates the illumination rise or a parallel arrangement of illuminants, or a parallel arrangement pitch of the partner connector fitting portion in the connector module and diversifies the specification (embodiment of the use) of the electric equipment module. Thereby, the usability of the electric equipment module improves.

According to the invention described in claim 4, the chattering of the base and the cover is eliminated, an allophone or wear, etc. by vibration are prevented, and the quality and reliability of the electric equipment module improve. Thereby, the usability of the electric equipment module improves further.

According to the invention described in claim 5, the joint effect of the above-mentioned claim 1 or 2 and claim 3 or 4 is demonstrated, and the quality and reliability of the electric equipment module improve further by the synergistic effect. Thereby, the usability of the electric equipment module improves further.

According to the invention described in claim 6, for example, the connection of a plurality of lamp modules accommodates the illumination rise or a parallel arrangement of illuminants, and diversifies the specification (embodiment of the use) thereof. Thereby, the usability of the lamp module improves.

1. An electric equipment module structure comprising a case having a base and a cover, wherein the case being disposed a terminal, an electric wire connecting the terminal being arranged in the base, a cutout portion being disposed in the base to bend and guide out the electric wire, an illuminant is disposed in the case, the terminal being electrically conducted to the illuminant, and an outside opening of the cutout portion being closed by the cover from above.

2. The electric equipment module structure described in claim 1, characterized in that a projection pressing the electric wire at the cutout portion is disposed, the electric wire being bent along the projection.

3. The electric equipment module structure as claimed in claim 1 or 2, the base and cover having a connection portion at one end and a connected portion at another end, respectively, a plurality of cases being possible to connect mutually.

4. The electric equipment module structure described in claim 3, characterized in that the connection portion biases the base and cover to the closing direction.

5. The electric equipment module structure described in claim 1 or 2, characterized in that a constitution of the electric equipment module structure described in claim 3 or 4 is provided.

6. (canceled)
